(19) United States
(12) Patent Application Publication
(10) Pub. No.: US 2025/0149757 A1
(43) Pub. Date: May 8, 2025

(54) BATTERY CELL TERMINAL WITH INTEGRATED CIRCUIT PROTECTION

(71) Applicant: FORD GLOBAL TECHNOLOGIES, LLC, Dearborn, MI (US)

(72) Inventors: Chansun Park, Southfield, MI (US); Qian Zhou, Northville, MI (US)

(21) Appl. No.: 18/501,622

(22) Filed: Nov. 3, 2023

(51) Int. Cl. H01M 50/562; H01M 4/62; H01M 4/76; H01M 50/553; H01M 50/581

(52) U.S. Cl. CPC H01M 50/562; H01M 4/626; H01M 4/762; H01M 50/553; H01M 50/581

(57) ABSTRACT

A battery cell comprises a housing, a current collector having a main body disposed in the housing and a terminal substrate extending from the housing and defining a cutout, and an electrically conductive filler material. The electrically conductive filler material is disposed within the cutout and cooperates with the substrate to form a terminal configured to connect with a load. The filler material has a lower melting point than the substrate and further cooperates with the substrate such that electric flux flows through both the substrate and the filler material when a temperature of the terminal is below a melting point of the filler material, and electric flux flows through only the substrate when the temperature of the terminal exceeds the melting point of the filler material.

### TECHNICAL FIELD

The present disclosure relates to battery cells and more specifically to terminals with integrated circuit protection.

### BACKGROUND

Vehicles such as battery-electric vehicles and hybrid-electric vehicles may contain a battery assembly to act as an energy source for the vehicle. The battery assembly may include a plurality of cells connected in series, parallel, or combinations thereof. Each battery cell may include one or more terminals for connecting the individual battery cells to a load.

### SUMMARY

According to one embodiment, a battery cell comprises a body, active battery material disposed within the body, and a terminal extending from the body and including a first end connected to the active battery material and a second end connectable to a load. A first material forms a first portion of the terminal and defines a first electrical path between the first and second ends, and a second material forms a second portion of the terminal and defines a second electrical path between the first and second ends. The second material has a lower melting point than the first material such that the second electrical path opens responsive to a temperature of the terminal exceeding the melting point of the second material causing the first path to carry all current of the load.

According to another embodiment, a battery cell comprises a body and discrete first and second materials of different melting points joined together to form a terminal. The terminal has a first end disposed within the body and a second end external to the body and connectable to a load. The first material is continuous between the first and second ends and the second material is contained to an intermediate portion of the terminal. The intermediate portion has a first cross-sectional area formed by both the first and second materials when a temperature of the terminal is below a threshold and a second, smaller cross-sectional area formed by only the continuous portion of the first material when the temperature of the terminal exceeds the threshold.

According to yet another embodiment, a battery cell comprises a housing, a current collector having a main body disposed in the housing and a terminal substrate extending from the housing and defining a cutout, and an electrically conductive filler material. The electrically conductive filler material is disposed within the cutout and cooperates with the substrate to form a terminal configured to connect with a load. The filler material has a lower melting point than the substrate and further cooperates with the substrate such that electric flux flows through both the substrate and the filler material when a temperature of the terminal is below a melting point of the filler material, and electric flux flows through only the substrate when the temperature of the terminal exceeds the melting point of the filler material.

### BRIEF DESCRIPTION OF THE DRAWINGS

FIG. 1 is a schematic diagram of an example hybrid vehicle.

FIG. 2 is a perspective view of an example battery cell.

FIG. 3 is a cross-sectional schematic diagram of an example battery cell.

FIG. 4A illustrates a terminal of a current collector according to an embodiment.

FIG. 4B illustrates the terminal of FIG. 4A after a first temperature threshold has been exceeded.

FIG. 4C illustrates the terminal of FIG. 4A after a second temperature threshold has been exceeded resulting in open circuit.

FIG. 5A illustrates a terminal of a current collector according to another embodiment.

FIG. 5B illustrates the terminal of FIG. 5A after a first temperature threshold has been exceeded.

FIG. 5C illustrates the terminal of FIG. 5A after a second temperature threshold has been exceeded resulting in an open circuit.

FIG. 6A illustrates a terminal of a current collector according to yet another embodiment.

FIG. 6B illustrates the terminal of FIG. 6A after a first temperature threshold has been exceeded.

FIG. 6C illustrates the terminal of FIG. 6A after a second temperature threshold has been exceeded resulting in an open circuit.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

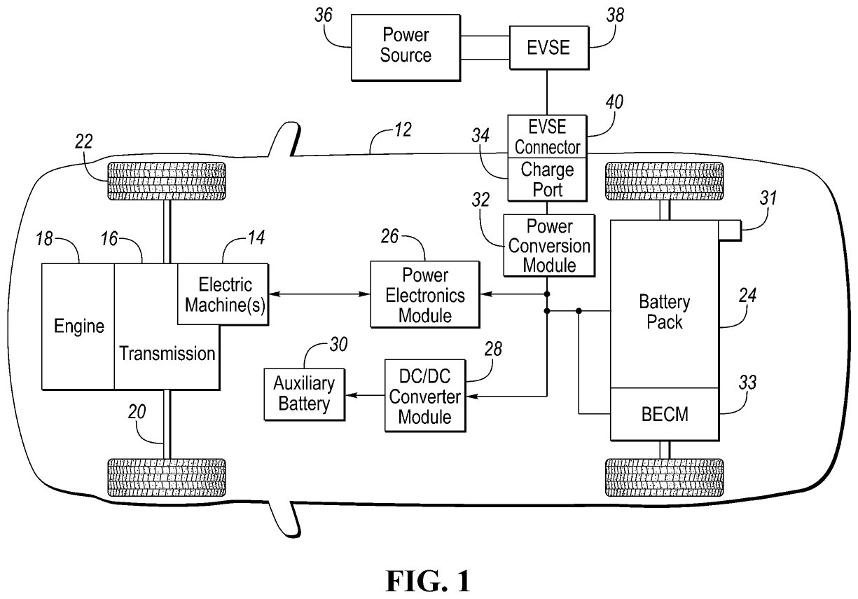

FIG. 1 depicts a schematic of a plug-in hybrid-electric vehicle (PHEV). Certain embodiments, however, may also be implemented within the context of non-plug-in hybrids and fully electric vehicles. The vehicle 12 includes one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned ON or OFF. The electric machines 14 also act as generators and can provide fuel economy benefits by recovering energy through regenerative braking.

A battery pack 24 stores energy that can be used by the electric machines 14. The battery pack 24 typically provides a high-voltage direct current (DC) output from one or more battery cell arrays, sometimes referred to as battery cell stacks, within the battery pack 24. The battery cell arrays include one or more battery cells.

The battery cells, such as a prismatic, pouch, cylindrical, or any other type of cell, convert stored chemical energy to electrical energy. The cells may include a housing, a positive electrode (cathode), and a negative electrode (anode). An electrolyte allows ions to move between the anode and cathode during discharge, and then return during recharge. Terminals may allow current to flow out of the cell for use by the vehicle.

Different battery pack configurations may be available to address individual vehicle variables including packaging constraints and power requirements. The battery cells may be thermally regulated with a thermal management system. Examples of thermal management systems include: air cooling systems, liquid cooling systems, and a combination of air and liquid systems.

The battery pack 24 may be electrically connected to one or more power electronics modules 26 through one or more contactors (not shown). The one or more contactors isolate the battery pack 24 from other components when opened and connect the battery pack 24 to other components when closed. The power electronics module 26 may be electrically connected to the electric machines 14 and may provide the ability to bi-directionally transfer electrical energy between the battery pack 24 and the electric machines 14. For example, a typical battery pack 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the battery pack 24. The description herein is equally applicable to fully electric vehicles. In a fully electric vehicle, the hybrid transmission 16 may be a gear box connected to an electric machine 14 and the engine 18 is not present.

In addition to providing energy for propulsion, the battery pack 24 may provide energy for other vehicle electrical systems. A typical system may include a DC/DC converter module 28 that converts the high voltage DC output of the battery pack 24 to a low voltage DC supply that is compatible with other vehicle components. Other high-voltage loads, such as compressors and electric heaters, may be connected directly to the high-voltage supply without the use of a DC/DC converter module 28. In a typical vehicle, the low-voltage systems are electrically connected to an auxiliary battery 30, e.g., a 12-volt battery.

A battery energy control module (BECM) 33 may be in communication with the battery pack 24. The BECM 33 may act as a controller for the battery pack 24 and may also include an electronic monitoring system that manages temperature and charge state of each of the battery cells. The battery pack 24 may have a temperature sensor 31 such as a thermistor or other temperature gauge. The temperature sensor 31 may be in communication with the BECM 33 to provide temperature data regarding the battery pack 24.

The vehicle 12 may be recharged by a charging station connected to an external power source 36. The external power source 36 may be electrically connected to electric vehicle supply equipment (EVSE) 38. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the battery pack 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus, e.g., Controller Area Network (CAN), or via dedicated electrical conduits.

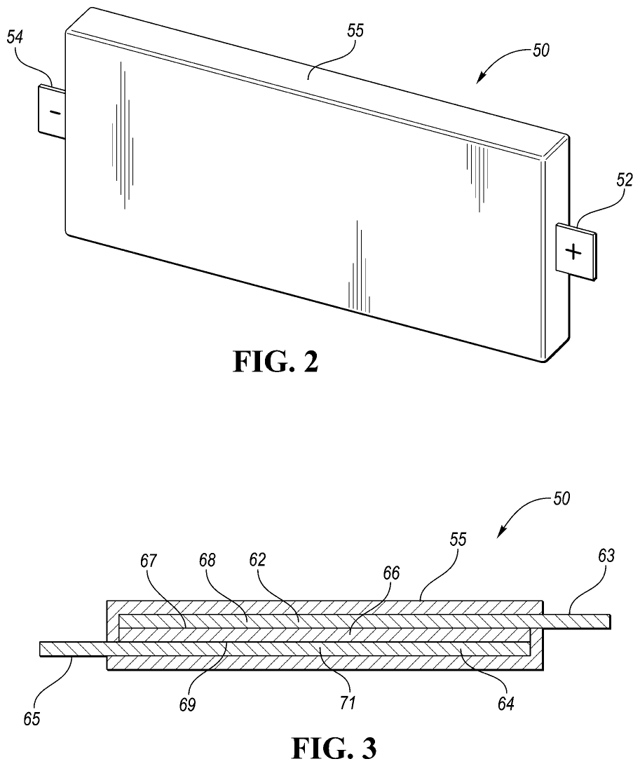

The battery pack 24 includes one or more battery arrays each having a plurality of batter cells arranged in a stack. An example battery cell 50 is shown in FIG. 2. The cells may be pouch cells, prismatic cells, cylindrical cells, or the like. Positive and negative terminals 52, 54 extend from an outer body or housing 55 of the cell 50. Each cell 50 may have two terminals, e.g., with the positive and negative terminals extending from different sides (as shown) or on a same side. Generally, within each cell is a cathode, an anode, a separator, and an electrolyte. Alternatively, the cell may have a solid electrolyte, wherein the solid electrolyte may act as a separator between the cathode and the anode. The positive terminal 52 is electrically connected to the cathode, and the negative terminal 54 is electrically connected to anode. The anode and the cathode may be referred to as electrodes.

FIG. 3 is a cross-sectional view through the exemplary battery cell 50. The battery cell 50 includes a cathode current collector 62, an anode current collector 64, and electrolyte 66. A separator (not shown) may be placed between the anode and cathode. An active material 67 may be disposed on one or both sides of the cathode current collector 62, and an active material 69 may be disposed on one or opposite both sides of the anode current collector 64. The active material 67, 69 may include materials such as graphite or other carbon-based materials, silicon, lithium cobalt oxide, lithium manganese oxide, lithium iron phosphate, lithium nickel manganese cobalt oxide, or combinations thereof.

The cathode current collector 62 may be formed from metal, such as aluminum, and may include a terminal 63 (also known as a tab) that is bare metal. The tab 63 projects from a main body 68 of the cathode current collector 62 from a housing 55 that encases the battery cell 50 as shown in FIG. 2. The tab 63 forms the positive terminal that is electrically connectable to a load.

An anode current collector 64 may be formed from metal, such as copper, and may include a terminal 65 (also known as a tab) that is bare metal. The tab 65 projects from a main body 71 of the current collector to may extend from the housing 55 that encases the battery cell 50 as shown in FIG. 2. The tab 65 forms the negative terminal that is electrically connectable to ground.

As will be described in detail below, one or more of the cell terminals may include an integrated circuit to passively control the flow of current therethrough. The circuit protection may be a quasi-integrated fuse. Unlike a fuse, which has a narrowed cross-sectional area for carrying current, the terminals of this disclosure maintain a full cross-sectional area during normal operation so that the addition of the circuit protection does not reduce performance compared to the terminal with the circuit protection.

The following figures and associated text describe example terminals that may be used in any of the above-described battery cells.

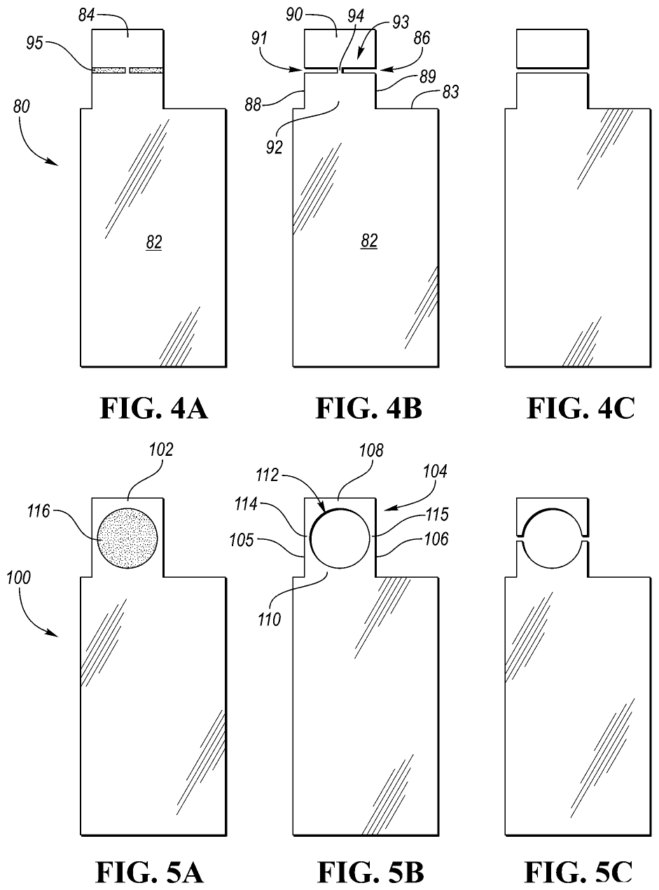

Referring to FIGS. 4A-4C, a current collector 80 may have a main body 82 and a terminal 84. The main body 82 may be disposed in a housing that encases a battery cell. The terminal 84 extends from a side 83 of the main body 82 to be external to the housing. The current collector 80 may be for an anode or a cathode. The terminal 84 includes a substrate 86. The substrate 86 may be integrally formed with the main body 82. The substrate 86 has a distal end portion 90 and a proximal end portion 92. The distal end portion 90 is connectable to a load, and the proximal end portion 92 is at the side 83 and located at least partially within the housing of the battery cell.

The substrate 86 includes opposing longitudinal sides 88, 89 that extend between the distal end portion 90 and the proximal end portion 92. A pair of cutouts, e.g., slots, 91, 93 are defined in the substrate 86. Each cutout 91, 93 extends inwardly from its associated longitudinal side. The cutouts 91, 93 are aligned with each other, i.e., are located at the same longitudinal position, to form a bridge 94 between the cutouts 91, 93. The bridge 94 in this example is a narrow strip of metal that extends in the longitudinal direction of the terminal 84 and forms an electrical path between the proximal end portion 92 and the distal end portion 90. In the illustrated embodiment, the portions 90 and 92 and the bridge 94 are all integrally formed portions of the substrate 86.

The cutouts 91, 93 and subsequently formed bridge 94 cause the substrate 86 to have different widths at different longitudinal locations. Since the substrate 86 may have a uniform thickness throughout, this creates different cross-sectional areas at different longitudinal locations of the substrate 86. In order to provide a full terminal width and cross-sectional area along the entire length of the terminal 84, an electrically conductive filler material 95 is added to the cutouts 91, 93.

The filler material 95 may be disposed within the cutouts 91, 93 as shown in FIG. 4A and cooperates with the substrate 86 to form the terminal 84. That is, the terminal 84, in a least one condition, consists of the substrate 86 and the filler material 95. The electrically conductive filler material 95 may be a low melting point alloy (LMPA) such as bismuth, gallium, tin, indium, zing, cadmium, tellurium, antimony, thallium, or combinations thereof. The LMPA may have a melting point lower than 400° C.

When a temperature of the substrate 86 is below the melting point of the electrically conductive filler material 95 (a first threshold temperature), electric flux flows through both the electrically conductive filler material 95 and the bridge 94. However, as shown in FIG. 4B, when a temperature of the terminal 84 exceeds the melting point of the filler material 95, the filler material 95 melts leaving only the substrate 86 to carry all of the current. The substrate 86 may be sized so that it alone can carry all of the rated currents. Thus, all of the electric flux flows through the narrow bridge 94, which forms a circuit protector. If the temperature of the bridge 94 exceeds a second threshold, the bridge 94 melts, electrically and physically disconnecting the distal end 90 from the proximal end 92 as shown in FIG. 4C.

Referring to FIGS. 5A-5C, another current collector 100 has a terminal 102 that includes a substrate 104. The substrate 104 includes opposing longitudinal sides 105, 106 that extend between a distal end portion 108 and a proximal end portion 110. The substrate 104 defines a cutout 112, e.g., a hole. The hole 112 may be circular, rectangular, or another geometry. The cutout 112 does not intersect the longitudinal sides 105, 106, and instead is entirely enclosed by the substrate 104 to form narrowed portions 114, 115 adjacent to the cutout 112 along the longitudinal sides 105, 106. The narrowed portions 114, 115 in this example are narrow strips of metal that extend in the longitudinal direction of the terminal 102 and form electrical paths between the proximal end portion 110 and the distal end portion 108. In the illustrated embodiment, the distal end portion 108, the proximal end portion 110, and the narrowed portions 114, 115 are all integrally formed portions of the substrate 104.

An electrically conductive filler material 116 may be disposed within the cutout 112 as shown in FIG. 5A and cooperates with the substrate 104 to form the terminal 102. That is, the terminal 102, in a least one condition, consists of the substrate 104 and the filler material 116. As described above, when a temperature of the substrate 104 is below a first threshold temperature, electric flux flows through both the electrically conductive filler material 116 and the narrowed portions 114, 115, and when a temperature of the substrate 104 exceeds the first threshold temperature, the filler material 116 melts leaving only the substrate 104 to carry all of the current as shown in FIG. 5B.

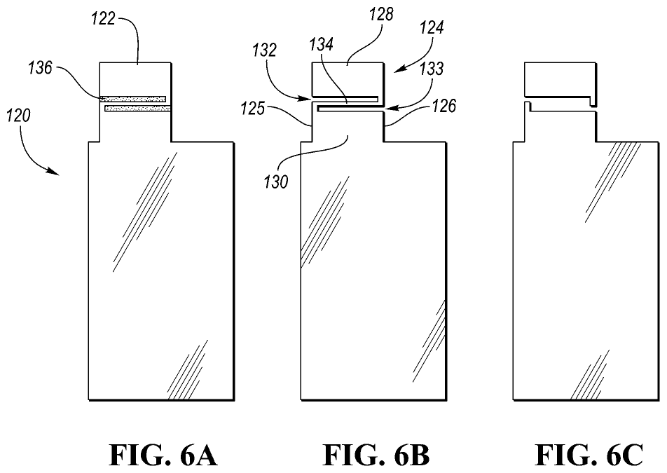

Referring to FIGS. 6A-6C, another current collector 120 has a terminal 122 that includes a substrate 124. The substrate 124 includes opposing longitudinal sides 125, 126 that extend between a distal end portion 128 and a proximal end portion 130. A pair of cutouts, e.g., slots, 132, 133 are defined in the substrate 124. Each cutout 132, 133 extends inwardly from its associated longitudinal side. The cutouts 132, 133 are not aligned with each other, i.e., are not located at the same longitudinal position, to form a narrowed path 134 between the cutouts 132, 133. The narrowed path 134 in this example is a narrow strip of metal that extends in the latitudinal direction of the terminal 122 and forms an electrical path between the proximal end portion 130 and the distal end portion 128. In the illustrated embodiment, the portions 128 and 130 and the narrowed path 134 are all integrally formed portions of the substrate 124.

An electrically conductive filler material 136 may be disposed within the cutouts 132, 133 as shown in FIG. 6A and cooperates with the substrate 124 to form the terminal 122. That is, the terminal 122, in a least one condition, consists of the substrate 124 and the filler material 136. As described above, when a temperature of the substrate 124 is below a first threshold temperature, electric flux flows through both the electrically conductive filler material 136 and the narrowed portion 134, and when a temperature of the substrate 124 exceeds the first threshold temperature, the filler material 136 melts leaving only the substrate 124 to carry all of the current as shown in FIG. 6B.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A battery cell comprising:
a body;
active battery material disposed within the body; and
a terminal extending from the body and including:
a first end connected to the active battery material,
a second end connectable to a load,
a first material forming a first portion of the terminal and defining a first electrical path between the first and second ends, and
a second material forming a second portion of the terminal and defining a second electrical path between the first and second ends; wherein
the second material has a lower melting point than the first material such that the second electrical path opens responsive to a temperature of the terminal exceeding the melting point of the second material causing the first path to carry all current of the load.

2. The battery cell of claim 1, wherein the first material and the second material are joined to cohesively form the terminal.

3. The battery cell of claim 1, wherein the first material is configured to open the first electrical path responsive a temperature of the terminal exceeding the melting point of the first material to electrically disconnect the second end from the first end.

4. The battery cell of claim 1, wherein the first and second ends are formed of the first material.

5. The battery cell of claim 1, wherein the terminal has a first width and the first material includes a narrow portion having a second width that is less than the first width.

6. The battery cell of claim 5, wherein the second material is adjacent to the narrow portion such that a combined width of the narrow portion and the second material is equal to the first width.

7. The battery cell of claim 6, wherein the terminal is rectangular.

8. The battery cell of claim 1, wherein the second material is an alloy including one or more of: bismuth, gallium, tin, indium, zinc, cadmium, tellurium, antimony, or thallium.

9. The battery cell of claim 1, wherein the second material has a melting point of less than or equal to 400 degrees Fahrenheit.

10. A battery cell comprising:
a body; and
discrete first and second materials of different melting points joined together to form a terminal having a first end disposed within the body and a second end external to the body and connectable to a load, wherein the first material is continuous between the first and second ends and the second material is contained to an intermediate portion of the terminal, wherein the intermediate portion has a first cross-sectional area formed by both the first and second materials when a temperature of the terminal is below a threshold, and the intermediate portion has a second, smaller cross-sectional area formed by only the first material when the temperature of the terminal exceeds the threshold.

11. The battery cell of claim 10, wherein the first material is configured to create an open circuit between the first and second ends at the intermediate portion responsive to a temperature of the intermediate portion exceeding the melting point of the first.

12. The battery cell of claim 10, wherein the second material is disposed on opposing sides of the first material at the intermediate portion.

13. The battery cell of claim 10, wherein the first material is copper or aluminum.

14. The battery cell of claim 13, wherein the second material is an alloy including one or more of: bismuth, gallium, tin, indium, zinc, cadmium, tellurium, antimony, or thallium.

15. The battery cell of claim 10, wherein the second material has a melting point of less than or equal to 400 degrees Fahrenheit.

16. A battery cell comprising:
a housing;
a current collector having a main body disposed in the housing and a terminal substrate extending from the main body and external to the housing, wherein the substrate defines a cutout; and
an electrically conductive filler material disposed within the cutout and cooperating with the substrate to form a terminal configured to connect with a load, wherein the filler material has a lower melting point than the substrate, and wherein the filler material cooperates with the substrate such that electric flux flows through both the substrate and the filler material when a temperature of the terminal is below a melting point of the filler material and such that electric flux flows through only the substrate when the temperature of the terminal exceeds the melting point of the filler material.

17. The battery cell of claim 16, wherein the substrate has a distal end and a proximal end connected by a bridge, and wherein a side of the bridge forms a side of the cutout.

18. The battery cell of claim 16, wherein the cutout is a first cutout and the substrate further defines a second cutout, wherein the first and second cutouts are located on opposing sides of the substrate.

19. The battery cell of claim 16, wherein the terminal substrate has opposing longitudinal sides, and the cutout is a hole located between the opposing sides.

20. The battery cell of claim 16, wherein the filler material is an alloy including one or more of: bismuth, gallium, tin, indium, zinc, cadmium, tellurium, antimony, or thallium.
